(19) United States
(12) Patent Application Publication
(10) Pub. No.: US 2012/0078438 A1
(43) Pub. Date: Mar. 29, 2012

(54) COMMISSIONING OF SENSORS

(76) Inventor: William J. Navas, Mayaguez, PR (US)

(21) Appl. No.: 13/375,297

(22) PCT Filed: Jul. 31, 2009
(86) PCT No.: PCT/US2009/052327

§ 371 Date: Nov. 30, 2011

(51) Int. Cl. G05D 23/00; G05B 23/02

(52) U.S. Cl. 700/300; 340/3.1

(57) ABSTRACT

A method (400) for commissioning a plurality of sensors in an environment cooled by a plurality of cooling devices includes measuring (410) an initial temperature at each of the plurality of sensors in the environment, modifying (420) a cooling setting of a first of the plurality of cooling devices, the cooling setting corresponding to an air handler temperature of the first cooling device and determining (430) an influence factor of the first of the plurality of cooling devices for each of the plurality of sensors, the influence factor including a magnitude of change and a rate of change for each of the plurality of sensors. A system is also provided.

### BACKGROUND

Computer system reliability depends on environmental stability. An information technology (IT) facility such as a data center typically includes an environmental control system intended to operate each system within a suitable range of conditions.

Data center managers and customers face a growing challenge managing the cooling and electrical specifications of diverse information technology (IT) equipment deployed in data centers. Some cooling systems provide an optimal data center temperature control by sending temperature and fan speed set points to the cooling devices within the data center. There is no industry standard in terms of physical layers and industrial communication protocols in the Heating, Ventilation and Air Conditioning Industry (HVAC).

### SUMMARY

A method for commissioning a plurality of sensors in an environment cooled by a plurality of cooling devices includes measuring an initial temperature at each of the plurality of sensors in the environment, modifying a cooling setting of a first of the plurality of cooling devices, the cooling setting corresponding to an air handler temperature of the first cooling device and determining an influence factor of the first of the plurality of cooling devices for each of the plurality of sensors, the influence factor including a magnitude of change and a rate of change for each of the plurality of sensors. A system is also provided.

### BRIEF DESCRIPTION OF THE DRAWINGS

Embodiments of the invention may best be understood by referring to the following description and accompanying drawings.

FIG. 1A shows a simplified perspective view of a data center, in accordance with one embodiment of the present technology.

FIG. 1B is a simplified plan view of the data center depicted in FIG. 1A in accordance with one embodiment of the present technology.

FIG. 2 is a block diagram of a sensor commissioning system in accordance with an embodiment of the present technology.

FIG. 3 illustrates a flow diagram of an operational mode of a method for commissioning sensors in accordance with an embodiment of the present technology.

FIG. 4 is a flow diagram of an embodiment of a method for commissioning sensors in accordance with one embodiment of the present technology.

FIG. 5 is a system diagram of an exemplary computer system in accordance with an embodiment of the present technology.

### DETAILED DESCRIPTION

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Furthermore, in the following detailed description, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “receiving”, “determining”, “enabling”, “accessing”, “modifying”, “associating”, “controlling”, “measuring”, “generating”, “initializing,” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology is also well suited to the use of other computer systems such as, for example, optical and mechanical computers.

A system and method for commissioning sensors is disclosed herein. More particularly, the sensors may be related to a number of actuators, for instance, CRAC units. The relationships are described in terms of actuator families and the sensors are assigned to respective actuator families based upon the relative effects that each actuator has on each sensor. Thus, for instance, a sensor may be assigned to an actuator family if the actuator of that family affects that sensor beyond a predefined threshold.

Data pertaining to correlations between the sensors and the actuators may be collected through different types of detected conditions. In a first example, temperature is the detected condition and the temperature of the airflow supplied by CRAC units is manipulated to obtain the data. In a second example, relative pressure is the detected condition and the flow rates at which airflow is supplied by CRAC units is manipulated to obtain the data. In a third example, absolute humidity is the detected condition and the level of humidification or dehumidification supplied into the airflow by CRAC units is manipulated to obtain the data.

The data may be used, in a first example, to form a neural network that establishes correlations between various CRAC unit settings and sensor measurements. In this example, the model created by the neural network may be implemented to assign the sensors to the CRAC unit families. In a second example, a curve fitting algorithm may be used to fit a multi-variant, polynomial function to the data set that defines the correlations between the sensors and the CRAC units. In this example, the calculated correlations may be used to assign the sensors to the CRAC unit families.

The systems and methods for commissioning sensors disclosed herein may be employed in any reasonably suitable environment containing actuators and sensors, such as, a building containing air conditioning units and sensors. In this regard, although particular reference is made throughout the present disclosure to data centers and CRAC units, it should be understood that the systems and methods disclosed herein may be implemented in other environments. In addition, therefore, the particular references to data centers and CRAC units are for illustrative purposes and are not intended to limit the systems and methods disclosed herein solely to data centers and CRAC units.

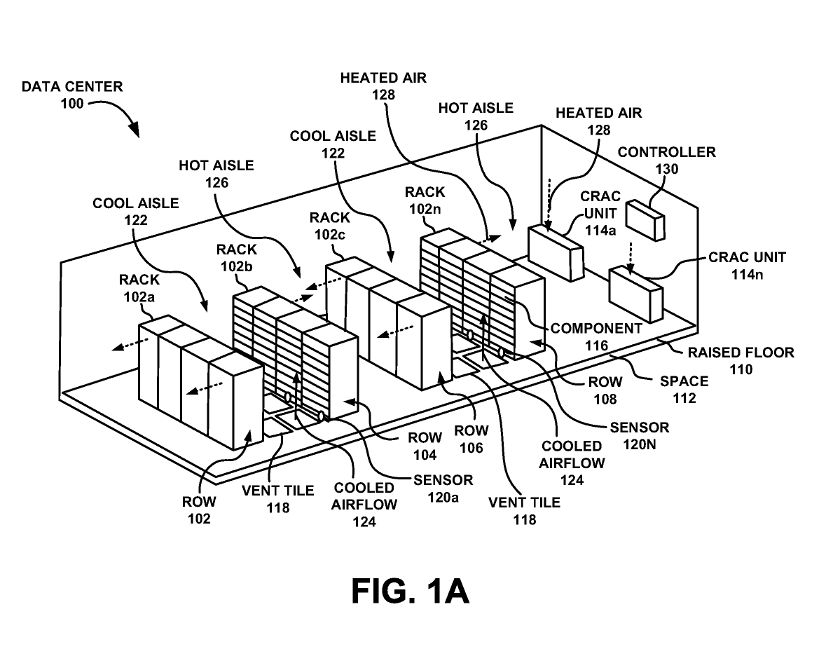

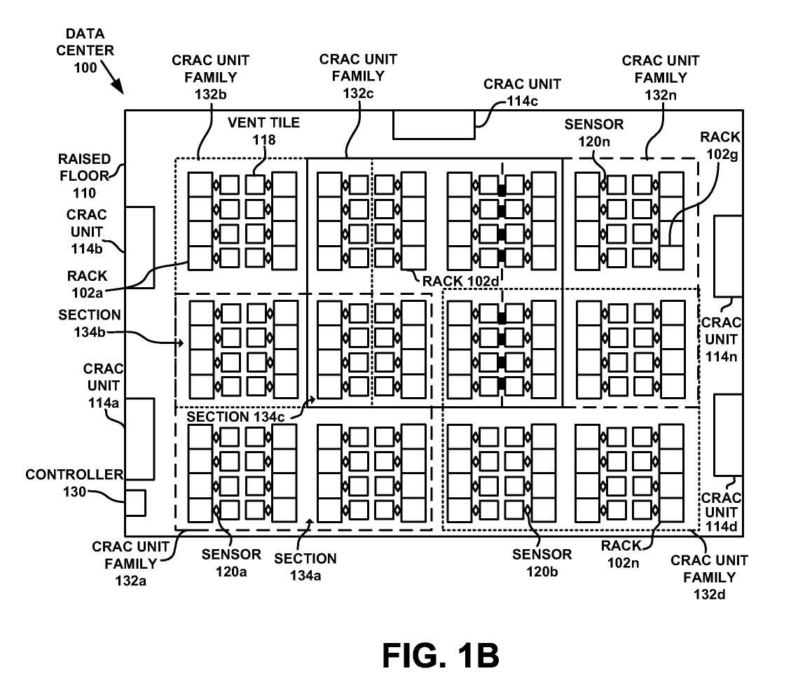

With reference first to FIG. 1A, there is shown a simplified perspective view of a section of a data center 100 which may employ various examples of the invention. The terms “data center” are generally meant to denote a room or other space where one or more components capable of generating heat may be situated. In this respect, the terms “data center” are not meant to limit the invention to any specific type of room where data is communicated or processed, nor should it be construed that use of the terms “data center” limits the invention in any respect other than its definition herein above.

It should be readily apparent that the data center 100 depicted in FIG. 1A represents a generalized illustration and that other components may be added or existing components may be removed or modified without departing from the scope of the invention. For example, the data center 100 may include any number of racks and various other components. In addition, it should also be understood that heat generating/dissipating components may be located in the data center 100 without being housed in racks.

The data center 100 is depicted as having a plurality of racks 102a-102n, where “n” is an integer greater than one. The racks 102a-102n may comprise, for instance, electronics cabinets, aligned in parallel rows. Each of the rows 102-108 of racks 102a-102n is shown as containing four racks 102a-102n positioned on a raised floor 110. A plurality of wires and communication lines (not shown) may be located in a space 112 beneath the raised floor 110. The space 112 may also function as a plenum for delivery of cooled air from one or more computer room air conditioning (CRAC) units 114a-114n, where “n” is an integer greater than one, to the racks 102a-102n. The cooled air may be delivered from the space 112 to the racks 102a-102n through vent tiles 118 located between some or all of the racks 102a-102n. The vent tiles 118 are shown as being located between rows 102 and 104 and 106 and 108.

The cooled air contained in the space 112 may include cooled aft supplied by one or more CRAC units 114a-114n. Thus, characteristics of the cooled aft, such as, temperature, pressure, flow rate, etc., may substantially be affected by one or more of the CRAC units 114a-114n. In this regard, characteristics of the cooled aft at various areas in the space 112 and the cooled aft supplied to the racks 102a-102n may vary, for instance, if the temperatures or the volume flow rates of the cooled air supplied by these CRAC units 114a-114n due to mixing of the cooled air. In other words, the characteristics of the cooled air supplied to a particular location in the data center 100 may differ from that of the cooled air supplied by a single CRAC unit 114a.

At least one condition, for instance, temperature, pressure, or humidity, of the cooled air supplied to various areas of the data center 100 may be detected by sensors 120a-120n designed to detect the at least one condition, where “n” is an integer greater than one. As shown, the sensors 120a-120n are represented as diamonds to distinguish them from other elements depicted in FIG. 1A. In addition, the sensors 120a-120n are depicted as being positioned to detect the at least one condition at the inlets of the racks 102a-102n. In this example, the sensors 120a-120n may comprise temperature sensors or absolute humidity sensors. In another example, the sensors 120a-120n may be positioned within the space 112 near respective vent tiles 118 to detect the temperature, pressure, or humidity of the cooled air supplied through the respective vent tiles 118.

In any regard, the sensors 120a-120n may be employed to detect the at least one condition at various CRAC unit 114a-114n settings. In addition, the sensors 120a-120n may be assigned to the families of one or more CRAC units 114a-114n. A CRAC unit 114a-114n “family” may be defined as a grouping of sensors 120a-120n that respond to the various CRAC unit 114a-114n settings to levels greater than a predefined threshold level. In other words, the sensor 120a may be considered as being in the CRAC unit 114a family if the response of the sensor 120a exceeds a predefined threshold level at various CRAC unit 114a-114n settings. Various manners in which the sensors 120a-120n may be assigned to one or more CRAC unit 114a-114n families is described in greater detail herein below.

The vent tiles 118 may comprise manually or remotely adjustable vent tiles. In this regard, the vent tiles 118 may be manipulated to vary, for instance, the mass flow rates of cooled aft supplied to the racks 102a-102n. In addition, the vent tiles 118 may comprise the dynamically controllable vent tiles disclosed and described in commonly assigned U.S. Pat. No. 6,574,104, the disclosure of which is hereby incorporated by reference in its entirety. As described in the U.S. Pat. No. 6,574,104 patent, the vent tiles 118 are termed “dynamically controllable” because they generally operate to control at least one of velocity, volume flow rate and direction of the cooled airflow there through. In addition, specific examples of dynamically controllable vent tiles 118 may be found in U.S. Pat. No. 6,694,759, filed on Jan. 27, 2003, which is assigned to the assignee of the present invention and is incorporated by reference herein in its entirety.

The racks 102a-102n are generally configured to house a plurality of components 116 capable of generating/dissipating heat, for instance, processors, micro-controllers, high-speed video cards, memories, semi-conductor devices, and the like. The components 116 may be elements of a plurality of subsystems (not shown), for instance, computers, servers, bladed servers, etc. The subsystems and the components may be operated to perform various electronic functions, for instance, computing, switching, routing, displaying, and the like.

The areas between the rows 102 and 104 and between the rows 106 and 108 may comprise cool aisles 122. These aisles are considered “cool aisles” because they are configured to receive cooled airflow from the vent tiles 118, as generally indicated by the arrows 124. In addition, and as shown, the racks 102a-102n generally receive cooled air from the cool aisles 122. The aisles between the rows 104 and 106, and on the rear sides of rows 102 and 108, are considered hot aisles 126. These aisles are considered “hot aisles” because they are positioned to receive air that has been heated by the components 116 in the racks 102a-102n, as indicated by the arrows 128.

The sides of the racks 102a-102n that face the cool aisles 122 may be considered as the fronts of the racks 102a-102n and the sides of the racks 102a-102n that face away from the cool aisles 122 may be considered as the rears of the racks 102a-102n. For purposes of simplicity and not of limitation, this nomenclature will be relied upon throughout the present disclosure to describe the various sides of the racks 102a-102n.

According to another example, the racks 102a-102n may be positioned with theft rear sides adjacent to one another (not shown). In this example, the vent tiles 118 may be provided in each aisle 122 and 126. In addition, the racks 102a-102n may comprise outlets on top panels thereof to enable heated air to flow out of the racks 102a-102n.

Also shown in FIG. 1A is a controller 130 configured to perform various functions in the data center 100. As described in greater detail herein below, the controller 130 may receive data from the CRAC units 114a-114n and the sensors 130 and may perform various computations on the data. In one regard, the controller 130 may operate to assign the sensors 130 into one or more CRAC unit 114a-114n families. Although the controller 130 is illustrated in FIG. 1A as comprising a component separate from the components 116 housed in the racks 102-108, the controller 130 may comprise one or more of the components 116 without departing from a scope of the data center 100 disclosed herein. In addition, or alternatively, the controller 130 may comprise software configured to operate on a computing device, for instance, one of the components 116.

The data center 100 is illustrated in FIG. 1A as containing four rows 102-108 of racks 102a-102n and two CRAC units 114a-114n for purposes of simplicity and illustration. Thus, the data center 100 should not be construed as being limited in any respect to the number of racks 102a-102n and CRAC units 114a-114n illustrated in FIG. 1A. In addition, although the racks 102a-102n have all been illustrated similarly, the racks 102a-102n may comprise heterogeneous configurations. For instance, the racks 102a-102n may be manufactured by different companies or the racks 102a-102n may be designed to house differing types of components 116, for example, horizontally mounted servers, bladed servers, etc.

With reference now to FIG. 1B, there is shown a simplified plan view of the data center 100 depicted in FIG. 1A. The data center 100 is shown as including CRAC units 114a-114n positioned at various locations throughout the data center 100. A plurality of vent tiles 118 are also illustrated in FIG. 1B and are configured to deliver cooled airflow to racks 102e-102n as described above. It should be appreciated that the data center 100 may include any reasonably suitable number of racks 102a-102n and CRAC units 114a-114n without departing from the data center 100 illustrated in FIG. 1B.

As described herein above, the vent tiles 118 and the racks 102a-102n are positioned on a raised floor 110, beneath which lies a space 112 (FIG. 1A). The space 112 is in fluid communication with the CRAC units 114a-114n and generally operates, in one respect, as a plenum for supplying cooling airflow from the CRAC units 114a-114n to be delivered through the vent tiles 118. In most instances, the space 112 may comprise a relatively open space that is accessible by cooling airflow supplied by a plurality of the CRAC units 114a-114n. In this regard, the cooling airflow supplied by the CRAC units 114a-114n may mix in the space 112. Therefore, the cooling airflow supplied to the racks 102a-102n by the vent tiles 118 may have originated from more than one of the CRAC units 114a-114n.

Also shown in FIG. 1B are the sensors 120a-120n, which are illustrated as being positioned with respect to each of the racks 102a-102n. As also stated above, the sensors 120a-120n may also, or in the alternative, be positioned to detect the at least one condition within the space 112. In any regard, the sensors 120a-120n may be grouped in various CRAC unit 114a-114n families based upon various criteria, as described in greater detail herein below. The various actuator or CRAC unit 114a-114n families 132a-132n corresponding to respective CRAC units 114a-114n are illustrated in FIG. 1B. As shown, the sensors 120a-120n are considered as being within the families 132a-132n of those CRAC units 114a-114n.

Some of the sensors 120a-120n, for instance, the sensors 120a-120n in a first section 134a may be included in the family 132a of a single CRAC unit 114a. Some of the other sensors 120a-120n, for instance, the sensors 120a-120n in a second section 134b may be included in the families 132a and 132b of two CRAC units 114a and 114b. In addition, some of the sensors 120a-120n, for instance, the sensors 120a-120n in a third section 134c may be included in the families 132a-132c of three CRAC units 114a-114c. As such, for instance, one or more of the sensors 120a-120n may belong to more than one CRAC unit 114a-114n family.

It should, in any regard, be understood that the families 132a-132n depicted in FIG. 1B are for purposes of illustration and are not intended to limit the data center 100 and its components in any respect. It should also be understood that the depiction of the famines 132a-132n in FIG. 1B are for illustrative purposes only and are not meant to limit the data center 100 in any respect.

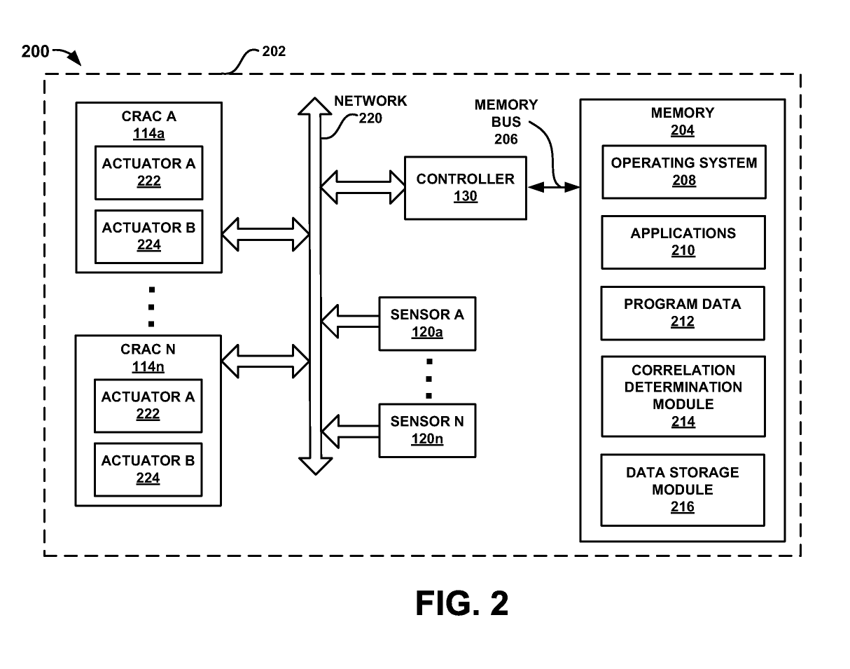

FIG. 2 is a block diagram 200 of a sensor commissioning system 202. It should be understood that the following description of the block diagram 200 is but one manner of a variety of different manners in which such a sensor commissioning system 202 may be configured. In addition, it should be understood that the sensor commissioning system 202 may include additional components and that some of the components described herein may be removed and/or modified without departing from the scope of the sensor commissioning system 202. For instance, the sensor commissioning system 202 may include any number of sensors, memories, processors, CRAC units, etc., as well as other components, which may be implemented in the operations of the sensor commissioning system 202.

As shown, the sensor commissioning system 202 includes the controller 130 depicted in FIGS. 1A and 1B. As described hereinabove, the controller 130 is configured to perform various functions in the data center 100. In this regard, the controller 130 may comprise a computing device, for instance, a computer system, a server, etc. In addition, the controller 130 may comprise a microprocessor, a micro-controller, an application specific integrated circuit (ASIC), and the like, configured to perform various processing functions. In addition, or alternatively, the controller 130 may comprise software operating in any of a number of computing devices.

The controller 130 is illustrated as being in communication with a memory 204 through, for instance, a memory bus 206. However, in certain instances, the memory 204 may form part of the controller 130 without departing from a scope of the sensor commissioning system 202. Generally speaking, the memory 204 may be configured to provide storage of software, algorithms, and the like, that provide the functionality of the controller 130. By way of example, the memory 204 may store an operating system 208, application programs 210, program data 212, and the like. In this regard, the memory 204 may be implemented as a combination of volatile and non-volatile memory, such as DRAM, EEPROM, MRAM, flash memory, and the like. In addition, or alternatively, the memory 204 may comprise a device configured to read from and write to a removable media, such as, a floppy disk, a CD-ROM, a DVD-ROM, or other optical or magnetic media.

The memory 204 may also store a correlation determination module 214, which the controller 130 may implement to perform various functions with respect to correlating the sensors 120a-120n with the CRAC units 114a-114n. More particularly, for instance, the correlation determination module 214 may be implemented to determine the CRAC unit 114a-114n families to which the sensors 120a-120n are assigned.

Also included in the memory 204 is a data storage module 216. The data storage module 216 may be implemented to store various data received from the CRAC units 114a-114n and the sensors 120a-120n. For instance, the data storage module 216 may store the received data in a data storage location in the memory 204. In addition, the data storage module 216 may be implemented to store the correlations between the sensors 120a-120n and the CRAC units 114a-114n. The data storage module 216 may store this correlation information in a variety of different manners. For instance, the data storage module 216 may store the information in the form of a look-up table. In addition, or alternatively, the data storage module 216 may store the information in the form of a map that may be employed to visualize the positions of the sensors 120a-120n and the families 132a-132n to which they are related.

Instructions from the controller 130 may be transmitted over a network 220 that operates to couple the various components of the sensor commissioning system 202. Although not shown, the controller 130 may be equipped with or have access to software and/or hardware to enable the controller 130 to transmit and receive data over the network 220. The network 220 generally represents a wired or wireless structure in the data center 100 for the transmission of data between the various components of the sensor commissioning system 202. The network 220 may comprise an existing network infrastructure or it may comprise a separate network configuration installed for the purpose of sensor commissioning by the controller 130.

The sensors 120a-120n may be configured to transmit collected data over the network 220 for storage and processing. As stated above, the sensors 120a-120n may comprise sensors configured to detect at least one environmental condition at various locations in the data center 100. The at least one environmental condition may comprise temperature, absolute humidity, or pressure and the sensors 120a-120n may be configured to detect at least one of these conditions. In addition, the controller 130 may vary operations of the correlation determination module 214 according to the type of environmental condition detected.

The controller 130 may transmit instructions over the network 220 to the CRAC units 114a-114n to vary operations of the CRAC units 114a-114n. As shown, the CRAC units 114a-114n each include an actuator A 222 and an actuator B 224. The actuators 222 and 224 generally comprise devices for controlling different aspects of the airflow supplied by the CRAC units 114a-114n, which are also actuators. More particularly, the CRAC units 114a-114n may be considered as primary actuators and the actuators 222 and 224 may be considered as secondary actuators.

By way of example, the actuators 222 may comprise airflow volume varying devices, such as, variable frequency drives (VFDs), fans, blowers, etc. Generally speaking, VFDs comprise actuators configured to vary the speeds at which the fans or blowers operate to thereby control the airflow volume supplied by the CRAC units 114a-114n. In addition, the actuators 224 may comprise airflow temperature varying devices, such as, water-chillers, compressors, valves, etc. Alternatively, the actuators 224 may comprise humidity varying-devices, such as, humidifiers and dehumidifiers. As described in greater detail herein below, the controller 130 may control the actuators 222 and 224 of the CRAC units 114a-114n to vary one or more characteristics of the airflow detected by the sensors 120a-120n. The conditions detected by the sensors 120a-120n at the various CRAC unit 114a-114n settings may be employed to commission the sensors 120a-120n with respect to the CRAC units 114a-114n.

In this regard, the CRAC units 114a-114n may include respective interfaces (not shown) that generally enable data transfer between the CRAC units 114a-114n and the controller 130 over the network 220. The interfaces may comprise any reasonably suitable hardware and/or software capable to enabling the data transfer over the network 220.

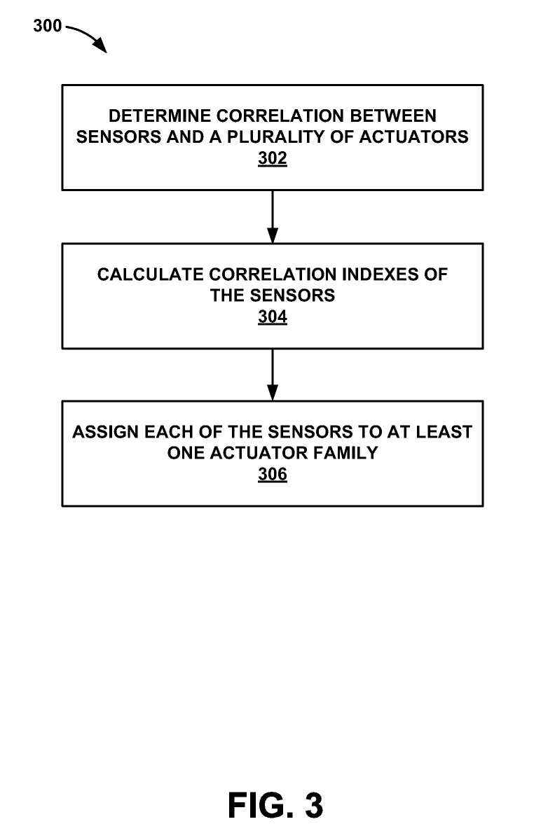

FIG. 3 illustrates a flow diagram of an operational mode 300 of a method for commissioning sensors, according to an example. It is to be understood that the following description of the operational mode 300 is but one manner of a variety of different manners in which an example of the invention may be practiced. It should also be apparent to those of ordinary skill in the art that the operational mode 300 represents a generalized illustration and that other steps may be added or existing steps may be removed, modified or rearranged without departing from a scope of the operational mode 300.

The description of the operational mode 300 is made with reference to the block diagram 200 illustrated in FIG. 2, and thus makes reference to the elements cited therein. It should, however, be understood that the operational mode 300 is not limited to the elements set forth in the block diagram 300. Instead, it should be understood that the operational mode 300 may be practiced by a sensor commissioning system having a different configuration than that set forth in the block diagram 200.

The operational mode 300 may be implemented to commission the sensors 120a-120n with respect to a plurality of actuators, for instance, CRAC units 114a-114n. More particularly, the operational mode 300 may be implemented to relate the sensors 120a-120n to the actuators. In addition, those sensors 120a-120n that are influenced to a predefined level by a particular actuator are considered to be within that actuator's family.

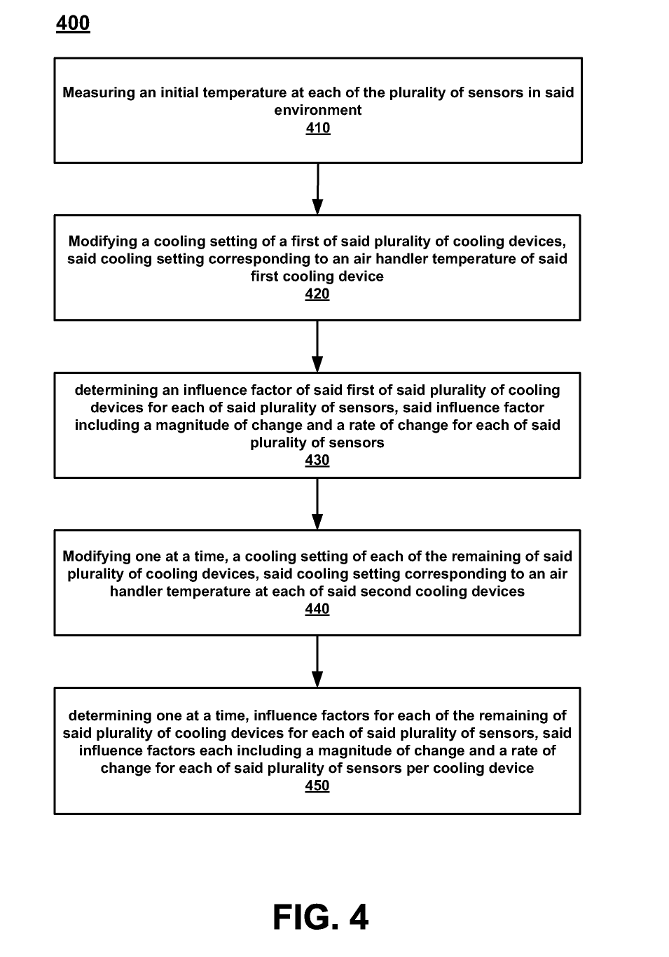

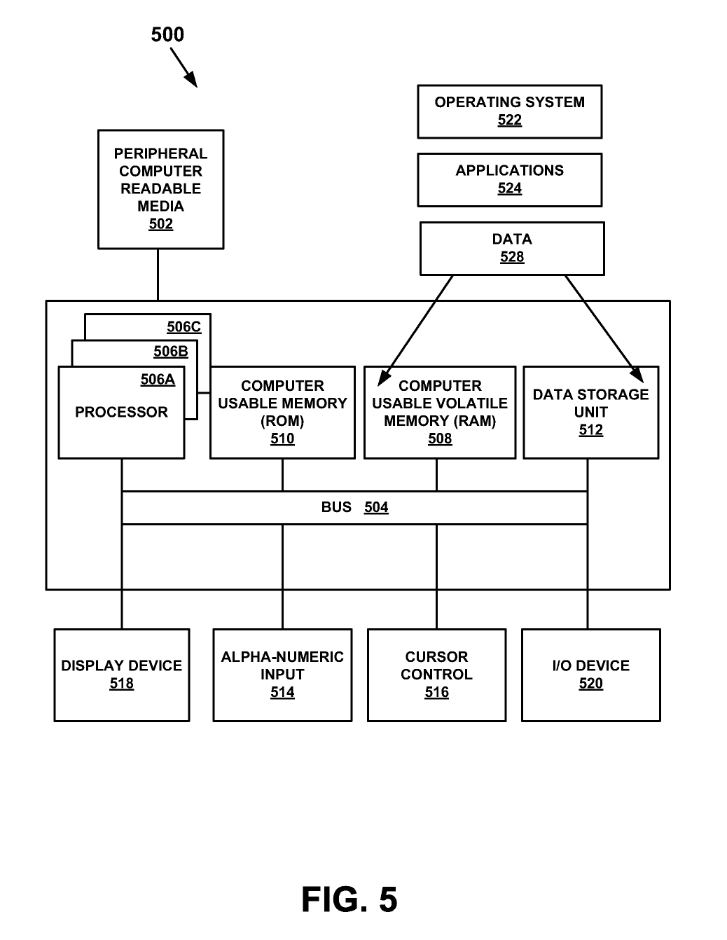

In the operational mode 300, the controller 130 may determine correlations between the sensors 120a-120n and a plurality of actuators at step 302. Manners in which these correlations may be determined are described in greater detail herein below with respect to the FIGS. 4-5. The controller 130 may also calculate correlation indexes of the sensors 120a-120n, which are functions of the plurality of actuator settings and a particular actuator, from the correlations at step 304. Examples of how the correlation indexes of the sensors 120a-120n may be calculated are described in greater detail herein below with respect to FIGS. 4-5. In addition, the controller 130 may assign each of the sensors 120a-120n to at least one actuator family at step 306.

### A Method for Sensor Commissioning without using TCI

In accordance with the present technology, commissioning means running an experiment that derives how a change in the CRACs supply air temperature can change a sensor's temperature. This result has been coined the Thermal Correlation Index (TCI). Embodiments of the present technology eliminate the use of TCI from commission of sensors which greatly improves efficiency of the commissioning process.

In one embodiment, the present technology uses a sensor network, a data collection device that takes samples from the network, a means for changing CRAC temperature set points and a method for changing CRAC set points and for computing correlations of the sensor signals and the CRAC temperature.

For all CRACs, perturbations are performed by changing CRAC temperature set points by some significant amount. Perturbations can be done by increasing and decreasing the temperature by a fixed amount and always returning to the starting point so that the operating point of the datacenter as a whole remains close to what it was before the perturbation. There is a fixed wait period between every change of set point on each perturbation. Data is sampled at regular intervals for both the air handling unit and the sensor temperature during each perturbation.

It is appreciated that any number of ways can be used to determine sensor correlations to CRACs without using TCI. Below is one example for determining a sensor correlation:
Let Xraw and Yraw be the data collected from CRAC units and sensors, respectively. Then let X and Y be the unbiased data set so that:

Y=Yraw−mean(Y)

X=Xraw−mean(X)

Where Y and X are matrices whose columns are time series of the unbiased temperatures collected for the sensors and CRACs respectively.
The correlations can then be computed by the vector projection ratio (VPR) or by simple least square estimation (LSE).

VPR=X^{T}Y/∥X∥² Equation (1)

LSE=(X^{T}X)⁻¹X^{T}Y Equation (2)

Embodiments of the present technology reduce the time for commission of sensors because there is no need for the temperature of the room to stabilize, as with using TCI. In addition, the perturbations of temperature at the CRAC and at the sensor are significantly reduced in addition to removing the requirement to perform a baseline perturbation as with using TCI.

In one embodiment, there is a plurality of sensors in an environment cooled by a plurality of cooling devices. At an initial state, the cooling of one of the plurality of cooling devices is modified, e.g., the unit is set to a lower set point.

At this point, the temperature of the environment is influence by one of the plurality of cooling devices and the influence of that one unit is measured at each of the plurality of sensors. In this way, an influence factor of that one cooling unit is determined for each of the sensors in the environment. In one embodiment, the influence factor includes a magnitude and a rate of change for that particular cooling device at each sensor.

In one embodiment, the influence factor can be determined prior to the environment coming to equilibrium after modifying the cooling of the first cooling device. In this way, the present invention reduces the time to commission a sensor.

Modifications are made to each of the cooling devices one at a time so that a cooling influence factor can be determined for each of cooling devices per sensor. In this way, each sensor will have a cooling influence factor associated with each of the cooling devices. The plurality of cooling influence factors for each sensor can be considered a cooling index for that sensor. The cooling indexes for each sensor can be used to more efficiently commission the plurality of sensors over conventional methods.

In one embodiment, the present invention commissions sensors without using the TCI as in conventional approaches. In one embodiment, the influence factor replaces the conventionally used TCI. One difference between using conventional TCI and the present invention of using an influence factor includes reduces time to commission sensors due to not requiring the environment to come to equilibrium for each modification to each cooling device. By not having to wait, the time to determine a plurality of influence factors for a number of cooling devices on a sensor is greatly reduced.

It is appreciated that the influence factor of the present invention can be determined in any number of ways and can include using a Pearson correlation. A Pearson correlation measures how well a linear relationship can be established between two variables. Looking at the collection of samples of sensor and CRAC temperatures as vectors. The Pearson correlation is the cosine of the angle between them. In one embodiment, a Pearson correlation may be used as the influence factor.

It is also appreciated that a slope ratio of the sensor samples with respect to the CRAC samples may be used in determining the influence factor. A slope ratio is a value that describes the difference between sensor values for a given variation of a particular cooling device. In one embodiment, the slope ratio may be used as the influence factor.

It is also appreciated that the vector projection ratio may be used in determining the influence factor. Looking at the collection of samples of sensor and CRAC temperatures as vectors, the vector projection ratio is the magnitude of the projection of the sensor vector onto the CRAC vector normalized by the length of the CRAC vector. In one embodiment, the vector projection ratio may be used as the influence factor.

It is appreciated that the vector projection ratio is mathematically identical to the slope ratio when only two samples of sensor and CRAC temperatures respectively are used to compute it. In one embodiment, the slope ratio might be used to compute the vector projection ratio using only two samples.

FIG. 4 is a flow diagram of an embodiment of a method 400 for commissioning sensors in accordance with one embodiment of the present technology.

At 410, 400 includes measuring an initial temperature at each of the plurality of sensors in the environment. In one embodiment, the present technology does not require a baseline temperature to begin the commissioning of sensors. The initial temperature of the environment can be used without the environment reaching equilibrium. In one embodiment, the sensors may reside in an air inlet or outlet of a computer storage location. Additionally, one or more of the sensors can be located in an air handling portion of one of the cooling devices.

At 420, 400 includes modifying a cooling setting of a first of the plurality of cooling devices, the cooling setting corresponding to an air handler temperature of said first cooling device. For example, if unit is currently not cooling, 420 would include initiating cooling at one of the cooling devices.

At 430, 400 includes determining an influence factor of the first of the plurality of cooling devices for each of the plurality of sensors, the influence factor including a magnitude of change and a rate of change for each of the plurality of sensors.

Method 400 improves efficiency of commissioning sensors over conventional method. The current technology reduces the time to commission sensors because it does not require stabilization of the environment when determining the influence of a particular cooling device on the sensors. Additionally, the influence factor of the present technology can be substituted for the conventional TCI metric which greatly improves the efficiency of the commissioning process.

### Example Computer System Environment

With reference now to FIG. 5, portions of the technology for cooling are composed of computer-readable and computer-executable instructions that reside, for example, in computer-usable storage media of a computer system. That is, FIG. 5 illustrates one example of a type of computer that can be used to implement embodiments, which are discussed below, of the present technology.

FIG. 5 illustrates an example computer system 500 used in accordance with embodiments of the present technology. It is appreciated that system 500 of FIG. 5 is an example only and that the present technology can operate on or within a number of different computer systems, including blade servers, general purpose networked computer systems, embedded computer systems, routers, switches, server devices, user devices, various intermediate devices/artifacts, stand alone computer systems, mobile phones, personal data assistants, and the like. It is also appreciated that system 500 may be one of a plurality of like systems that can be combined and partitioned in accordance with embodiments of the present technology. In one embodiment, system 500 is a single blade computer system of a multi-blade server system. However, in another embodiment, system 500 is a multi-blade computer server system.

As shown in FIG. 5, computer system 500 of FIG. 5 is well adapted to having peripheral computer readable media 502 such as, for example, a floppy disk, a compact disc, and the like coupled thereto.

System 500 of FIG. 5 includes an address/data bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g. random access memory (RAM), coupled to bus 504 for storing information and instructions for processors 506A, 506B, and 5060.

System 500 also includes computer usable non-volatile memory 510, e.g. read only memory (ROM), coupled to bus 504 for storing static information and instructions for processors 506A, 506B, and 5060. Also present in system 500 is a data storage unit 512 (e.g., a magnetic or optical disk and disk drive) coupled to bus 504 for storing information and instructions. System 500 also includes an optional alpha-numeric input device 514 including alphanumeric and function keys coupled to bus 504 for communicating information and command selections to processor 506A or processors 506A, 506B, and 5060. System 500 also includes an optional cursor control device 516 coupled to bus 504 for communicating user input information and command selections to processor 506A or processors 506A, 506B, and 5060. System 500 of the present embodiment also includes an optional display device 518 coupled to bus 504 for displaying information.

Referring still to FIG. 5, optional display device 518 may be a liquid crystal device, cathode ray tube, plasma display device or other display device suitable for creating graphic images and alpha-numeric characters recognizable to a user. Optional cursor control device 516 allows the computer user to dynamically signal the movement of a visible symbol (cursor) on a display screen of display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

System 500 is also well suited to having a cursor directed by other means such as, for example, voice commands. System 500 also includes an I/O device 520 for coupling system 500 with external entities. For example, in one embodiment, I/O device 520 is a network device for enabling wired or wireless communications between system 500 and an external network such as, but not limited to, the Internet.

Referring still to FIG. 5, various other components are depicted for system 500. Specifically, when present, an operating system 522, applications 524, and data 528 are shown as typically residing in one or some combination of computer usable volatile memory 508, e.g. random access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology is stored as BIOS/System Firmware in memory locations within RAM 508 and memory areas ROM 510.

The computing system 500 is only one example of a suitable computing environment and is not intended to suggest any limitation as to the scope of use or functionality of the present technology. Neither should the computing environment 500 be interpreted as having any dependency or requirement relating to any one or combination of components illustrated in the example computing system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

The various functions, processes, methods, and operations performed or executed by the system can be implemented as programs that are executable on various types of processors, controllers, central processing units, microprocessors, digital signal processors, state machines, programmable logic arrays, and the like or any combination thereof. The programs can be stored on any computer-readable storage medium for use by or in connection with any computer-related system or method. A computer-readable medium is an electronic, magnetic, optical, or other physical device or means that can contain or store a computer program for use by or in connection with a computer-related system, method, process, or procedure. Programs and logic instructions can be embodied in a computer-readable medium for use by or in connection with an instruction execution system, device, component, element, or apparatus, such as a system based on a computer or processor, or other system that can fetch instructions from an instruction memory or storage of any appropriate type.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, and conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. The illustrative techniques may be used with any suitable data center configuration and with any suitable servers, computers, and devices.

What is claimed is:

1. A method (400) for commissioning a plurality of sensors in an environment cooled by a plurality of cooling devices comprising:
measuring (410) an initial temperature at each of the plurality of sensors in said environment;
modifying (420) a cooling setting of a first of said plurality of cooling devices, said cooling setting corresponding to an air handler temperature of said first cooling device; and
determining (430) an influence factor of said first of said plurality of cooling devices for each of said plurality of sensors, said influence factor including a magnitude of change and a rate of change for each of said plurality of sensors.

2. The method (400) of claim 1 further comprising:
modifying (440) a cooling setting of a second of said plurality of cooling devices, said cooling setting corresponding to an air handler temperature of said second cooling device; and
determining (450) an influence Factor of said second of said plurality of cooling devices for each of said plurality of sensors, said influence factor including a magnitude of change and a rate of change for each of said plurality of sensors.

3. The method (400) of claim 1 further comprising:
modifying (440) one at a time, a cooling setting of each of the remaining of said plurality of cooling devices, said cooling setting corresponding to an air handler temperature at each of said second cooling devices; and
determining (450) one at a time, influence factors for each of the remaining of said plurality of cooling devices for each of said plurality of sensors, said influence factors each including a magnitude of change and a rate of change for each of said plurality of sensors per cooling device.

4. The method (400) of claim 3 further comprising:
determining (450) a correlation index for each of said plurality of sensors, said correlation index including an influence factor for each of said plurality of cooling devices on a particular sensor.

5. The method (400) of claim 1 wherein one of said plurality of sensors is at an air inlet associated with a computer system.

6. The method (400) of claim 1 wherein one of said plurality of sensors is at an air outlet associated with a computer system.

7. The method (400) of claim 1 wherein one of said plurality of sensors is at an air handler associated with one of said plurality of cooling devices.

8. The method (400) of claim 1 wherein said determining (430) said influence factor of said first of said plurality of cooling devices for each of said plurality of sensors is performed prior to said environment stabilizing in response to said modifying said cooling setting of said first of said plurality of cooling devices.

9. The method (400) of claim 1 wherein said rate of change includes an angle of change.

10. A computer readable storage medium (510) comprising instructions that when executed cause said computer (500) to perform a method (400) for commissioning a plurality of sensors in an environment cooled by a plurality of cooling devices, said method comprising:
measuring (410) an initial temperature at each of the plurality of sensors in said environment;
modifying (420) a cooling setting of a first of said plurality of cooling devices, said cooling setting corresponding to an air handler temperature of said first cooling device; and
determining (430) an influence factor of said first of said plurality of cooling devices for each of said plurality of sensors, said influence factor including a magnitude of change and a rate of change for each of said plurality of sensors prior to said environment reaching an equilibrium after said modifying said cooling setting of said first of said plurality of cooling devices.

11. The computer readable storage medium (510) of claim 10 wherein said method (400) further comprises:
modifying (440) a cooling setting of a second of said plurality of cooling devices, said cooling setting corresponding to an air handler temperature of said second cooling device; and
determining (450) an influence factor of said second of said plurality of cooling devices for each of said plurality of sensors, said influence factor including a magnitude of change and a rate of change for each of said plurality of sensors.

12. The computer readable storage medium (510) of claim 10 wherein said method (400) further comprises:
modifying (440) one at a time, a cooling setting of each of the remaining of said plurality of cooling devices, said cooling setting corresponding to an air handler temperature at each of said second cooling devices; and
determining (450) one at a time, influence factors for each of the remaining of said plurality of cooling devices for each of said plurality of sensors, said influence factors each including a magnitude of change and a rate of change for each of said plurality of sensors per cooling device.

13. The computer readable storage medium (510) of claim 12 wherein said method (400) further comprises:
determining (450) a correlation index for each of said plurality of sensors, said correlation index including an influence factor for each of said plurality of cooling devices on a particular sensor.

14. The computer readable storage medium (510) of claim 10 wherein said influence factor for one of said plurality of sensors is determined at an air inlet associated with a computer system.

15. The computer readable storage medium (510) of claim 10 wherein said influence factor for one of said plurality of sensors is determined at an air outlet associated with a computer system.

16. The computer readable storage medium (510) of claim 10 wherein said influence factor for one of said plurality of sensors is determined at an air handler associated with one of said plurality of cooling devices.

17. The computer readable storage medium (510) of claim 10 wherein said determining (430) said influence factor of said first of said plurality of cooling devices for each of said plurality of sensors is performed prior to said environment stabilizing in response to said modifying said cooling setting of said first of said plurality of cooling devices.

18. The computer readable storage medium (510) of claim 10 wherein said rate of change includes an angle of change.

19. A system (200) for commission a plurality of sensors in an environment cooled by a plurality of cooling devices comprising:
a plurality of sensors (120) for measuring an initial temperature at each of said plurality of sensors in said environment;
a cooling unit controller (130) coupled with each of said cooling devices for modifying a cooling setting of a first of said plurality of cooling devices, said cooling setting corresponding to an air handler temperature of said first cooling device; and
a sensor commissioner (200) coupled with said sensors and coupled with said cooling unit controller for determining an influence factor of said first of said plurality of cooling devices for each of said plurality of sensors, said influence factor including a magnitude of change and a rate of change for each of said plurality of sensors.

20. The system (200) of claim 19 wherein said cooling unit controller is a dynamic smart cooling device.

21. The system (200) of claim 19 wherein said sensor commissioner (202) determines said influence factor of said first of said plurality of cooling devices for each of said plurality of sensors prior to said environment stabilizing in response to said modifying said cooling setting of said first of said plurality of cooling devices.
